(19) United States
(12) Patent Application Publication
(10) Pub. No.: US 2004/0201444 A1
(43) Pub. Date: Oct. 14, 2004

(54) Shape memory alloy actuators activated by strain gradient variation during phase transformation

(76) Inventors: Byong-Ho Park, San Francisco, CA (US); Friedrich B. Prinz, Menlo Park, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/754,472

(22) Filed: Jan. 8, 2004

Related U.S. Application Data
(63) Continuation-in-part of application No. 10/029,402, filed on Dec. 19, 2001, now abandoned.
(60) Provisional application No. 60/260,169, filed on Jan. 5, 2001.
(60) Provisional application No. 60/257,214, filed on Dec. 20, 2000.

(51) Int. Cl. H01H 71/18

(52) U.S. Cl. 337/139

(57) ABSTRACT

The present invention provides actuators and actuator devices that take advantage of a strain gradient variation of an actuator element between a first phase and a second phase. The actuator elements can be positioned in any type of shape. For instance, the actuator element in the first phase can be any type of curved, non-linear or irregular shape as long as a strain gradient along a cross-section of the actuator element can be established. The actuator element in the second phase is positioned in a different shape when compared to the first phase as long as it is in a direction to minimize the strain gradient. Different actions can be generated such as a rotary movement, a linear movement, an expanding movement, or a combined linear and rotary movement. The actuator element could also be configured to generate a linear movement by combining contraction and strain gradient variation.

### CROSS-REFERENCE TO RELATED APPLICATIONS

This application is a continuation-in-part of a pending U.S. patent application Ser. No. 10/029,402, filed Dec. 19, 2001, which claims priority from U.S. Provisional Patent Applications No. 60/260,169, filed Jan. 05, 2001, and No. 60/257,214, filed Dec. 20, 2000.

### STATEMENT REGARDING FEDERALLY SPONDORED RESEARCH OR DEVELOPMENT

This invention was supported in part by grant number F49620-99-1-0129 from the Air Force Office of Science Research. The U.S. government may have certain rights in the invention.

### FIELD OF THE INVENTION

This invention relates generally to shape memory alloys. More particularly, the present invention relates to shape memory alloy actuators that are activated by strain gradient variation during phase transformation.

### BACKGROUND

Shape memory alloy (SMA) actuators have advantages of, for instance, high power density (>1000 W/kg), large stress (>200 MPa) and large strain (˜4%) when compared to other actuators such as piezoelectric and electrostatic actuators. Taking advantages of SMA actuators, there exist various kinds of actuator systems that can have motions with strong force. The general type of SMA actuators is a wire due to its robust performance, long life cycle and low fabrication complexity. In general, SMA actuators are based on the shortening or contraction of SMA wires, because SMA wires have maximum force in the direction of contraction, see, for instance, U.S. Pat. Nos. 4,761,955, 4,979,672, 5,396,769, 5,127,228, 5,808,837, 5,825,275 and 6,242,841.

Thus, in conventional SMA actuators, SMA wires are arranged in such a way as to maximize performance in the direction of contraction. Following this approach, conventional SMA actuators can generally achieve a maximum force of about 600 MPa out of SMA wires.

The main disadvantage of this approach is the dependency of the wire displacement on actuator sizes. For instance, if the SMA actuators are required to have certain angular deflection, the requirement cannot be satisfied without keeping the length of SMA wires identical while the actuators are scaled down due to fixed contraction strains (4˜5%). This argues against the miniaturization of conventional SMA actuator systems.

Some prior art teaches SMA rotary actuator devices. These rotary device are built by winding SMA wires around a rotating shaft and using the contraction or shortening of the SMA wires as the main actuator mechanism. As mentioned above, this approach has crucial disadvantages in scaling down actuator sizes since it requires the long length of wires to achieve large enough angular deflection due to the fixed contraction strains (4˜5%). In addition, wire-winding itself adds complexity and affects robustness of the actuators.

U.S. Pat. No. 4,411,711, issued to Albrecht et al., discloses a process to induce a reversible two-way shape memory effect in a component made from a material that shows a one-way shape memory effect. Albrecht et al. distinguish shape memory alloys between those with one-way effect and those with two-way effect. The two-way effect is more problematic and difficult to control. On the other hand, certain shape memory alloys have a remarkable one-way effect but a negligible two-way effect. Albrecht et al. developed a special treatment to induce noticeable two-way shape memory effect in components made of alloys normally exhibiting a one-way shape memory effect, e.g., a bending rod made of Cu—Al—Ni alloy having a dimension of 2.5 mm by 2.5 mm by 35.0 mm. The special treatment of Albrecht et al. require the rod to be solution treated for 15 minutes at a temperature of 950° C. and then water quenched. Thereafter, one side of the rod is shot peened for two minutes. This treatment induced a two-way shape memory effect in the rod such that, upon heating to 220° C., the rod moves in a direction contrary to that induced by shot peening. Albrecht et al. were thus able to induce a strain, which is a two-way effect, out of a one-way shape memory alloy.

Unfortunately, the deflection is very minimal and the strain so induced is very small, approximately 0.6%. Moreover, the process of Albrecht et al. is not suitable for miniaturization of SMA actuators.

Accordingly, there is a need for new SMA actuators capable of achieving large movements and/or deflections and new approaches enabling miniaturization of the SMA actuators.

### SUMMARY OF THE INVENTION

The present invention provides actuators that take advantage of the strain gradient variation of an actuator element. In particular, the present invention provides actuators that take advantage of the strain gradient changes between a first phase and a second phase. In a preferred embodiment, the actuator element includes a shape memory alloy and the first state is a Martensite phase of the shape memory alloy and the second phase is an Austenite phase of the shape memory alloy.

The actuator elements of the present invention can be positioned in any type of shape. For instance, the actuator element in the first phase can be any type of curved, non-linear or irregular shape as long as a strain gradient along a cross-section of the actuator element can be established. The actuator element in the second phase is positioned in a different shape when compared to the shape in the first phase as long as it is in a direction to minimize the strain gradient.

The actuator of the present invention can be configured to generate different actions or movements when transitioning and taking advantage of the strain gradient variation from the first phase to the second phase. Examples of such movements are, but not limited to, a rotary movement, a linear movement, an expanding movement, or a combined linear and rotary movement. The actuator of the present invention could also be configured to generate a linear movement by combining contraction and strain gradient variation.

The present invention also provides a method of making an actuator. The method includes establishing a strain gradient between a first phase and a second phase of an actuator element. Furthermore, the method includes activating the actuator element to transition the actuator element from the first phase to the second phase.

The actuator of the present invention is also provided as an actuator device wherein the actuator is included as part of a device such as, but not limited to, a medical device, a robotic device, a joint mechanism, a switch, a relay, and the like. The actuator is integrated or embedded in the actuator device. The actuator device includes a first body. An actuator element with a first end is attached to the first body. In one embodiment, the actuator device of the present invention could further include a second body that is attached to a second end of the actuator element. The first body is then movably attached to the second body by a connecting means, such as, but not limited to, a joint. In an alternative embodiment, the actuator device of the present invention further includes a second body wherein the second body is attached to a point in between the first end and the second end of the actuator element. The second end is now attached to the first body.

The present invention also provides a method of making an actuator device. The method includes attaching a first end of an actuator element to a first body, activating the actuator element to transition the actuator element from the first phase to the second phase of the strain gradient. In one embodiment, the method further includes attaching a second end of the actuator element to a second body. The first body is movably attached to the second body by a connecting means, such as, but not limited to, a joint. In an alternative embodiment, the second body is attached to a point in between the first end and the second end of the actuator element. The second end is attached to the first body. Furthermore, the method includes embedding the actuator element in the actuator device.

In view of the foregoing, it is therefore an object of the present invention to provide an actuator with an actuator element that actuates based on a strain gradient variation between a first phase and a second phase thereof.

It is another object of the present invention to provide actuators with different configurations.

It is yet another object of the present invention to provide an actuator that undergoes a transition from the first phase to the second phase in a direction to minimize the strain gradient.

It is still another object of the present invention to provide an actuator to generate a rotary movement when transitioning from the first phase to the second phase.

It is a further object of the present invention to provide an actuator to generate a linear movement when transitioning from the first phase to the second phase.

It is still another object of the present invention to provide an actuator to generate combined linear and rotary movement when transitioning from the first phase to the second phase.

It is still another object of the present invention to provide an actuator to generate a linear movement by combining contraction and strain gradient variation.

It is still another object of the present invention to enable miniaturization of SMA actuators to meso or micro-scale.

It is still another object of the present invention to provide an actuator device and locally place the actuator in the actuator device.

It is still another object of the present invention to provide an actuator device and embed the actuator in the actuator device.

The present invention advantageous enables one to develop actuators and actuator devices that can achieve large deflections and/or movements without the need of long wires. Another advantage of the present invention is that the actuators and actuator devices can be scaled down and miniaturized to meso or micro-scale, which is difficult and hard to accomplish with contraction of the actuator element. Yet another advantage of the present invention is that the actuators and actuator devices become simple and robust by having SMAs locally placed or embedded in the actuator parts or device. Furthermore, as the sizes of the actuators decrease, the present invention offers more advantages in terms of cooling effects of SMA wires, which is directly related to the bandwidth of actuator systems.

### BRIEF DESCRIPTION OF THE FIGURES

The objectives and advantages of the present invention will become apparent to one of ordinary skill in the art upon reading and understanding the following detailed description in conjunction with the drawings, in which:

FIG. 1 shows developing a strain gradient of an actuator according to the present invention;

FIG. 2 shows an example of a strain distribution of an actuator according to the present invention;

FIG. 3 shows an example of an actuator movement according to the present invention;

FIG. 4 shows an exemplary embodiment of a configuration of an actuator that provides a push motion according to the present invention;

FIG. 5 shows an exemplary embodiment of a configuration of an actuator that provides a pull and expanding motion according to the present invention; and

FIGS. 6-7 shows exemplary embodiments of an actuator device according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

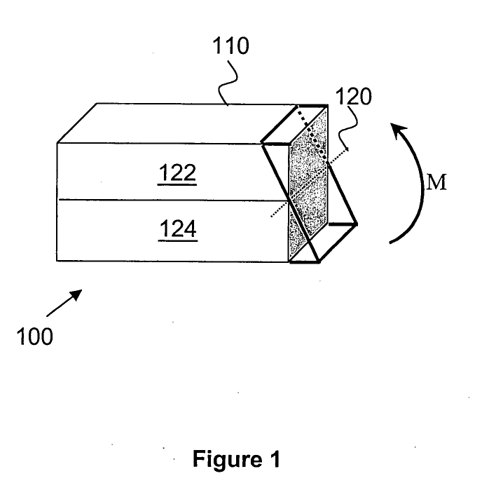

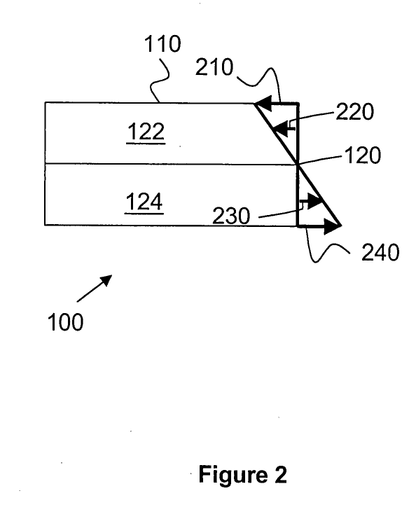

The present invention provides an actuator 100 with an actuator element 110 that is based on a strain gradient as shown in FIG. 1. The strain gradient varies between a first phase and a second phase. In the first phase, actuator element 110 has a higher strain gradient than in the second phase. In other words, the strain gradient minimizes when the actuator element transitions from the first phase to the second phase. In the example of FIG. 1, the strain gradient is defined relative to a neutral axis 120 of actuator element 110 along a cross-section of the actuator element. A torque M is applied that develops the strain gradient to actuator element 110 bringing one part of actuator element 110 under compression 122 and another part of actuator element 110 under tension 124. FIG. 2 shows the different strain distributions 210, 220 (both compression) and 230, 240 (both tension) of actuator element 110. Actuator element 110 is preferably a shape memory alloy (SMA), but could be any type of actuator that can retain a strain gradient variation. Different SMA materials could be used, such as, nitinol or any superelastic material. An SMA is preferably and conveniently a wire, but could take any other form suitable for its application.

An activating means (not shown) activates actuator element 110 and generates the transition from the first phase to the second phase. SMA is subject to a temperature change. In that case, the actuator means includes a heating means to activate the SMA and provide the transition from the first phase to the second phase. The first phase in an SMA is called Martensite phase (low temperature, e.g. room temperature) and the second phase in an SMA is called Austenite phase (high temperature). At a low temperature an SMA wire has a low stiffness because it is in its Martensite phase and exhibits a Young's Modulus of about 28 MPa. At a high temperature the SMA wire has a high stiffness due to its transition to the Austenite phase. In this phase the SMA wire has a Young's Modulus of about 75 MPa. In addition to the pure modulus change, there is another contribution of the strain gradient, which is a shortening and widening of SMA wires during contraction. In accordance with the present invention, these strain gradient changes make it possible to provide an actuator, such as a rotary actuator, which uses a comparatively short length of wire to obtain a large angular movement or deflection.

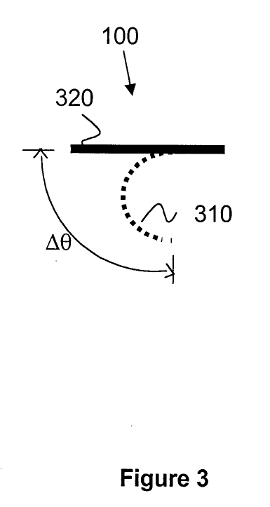

As shown in an exemplary embodiment in FIG. 3, actuator element 110 has a certain strain gradient in a curved shape 310, which is the first phase. The strain gradient decreases during the phase transformation by straightening curved shaped 310 into a linear shape 320, which is the second phase. By taking advantage of this strain gradient variation during the SMA phase transformation from the first phase to the second phase, the actuators of the present invention can achieve large deflection, of approximately 90°, as indicated by Δθ. Therefore, the actuators of the present invention can be scaled down and miniaturized to meso or micro-scale range without losing functionality.

The actuator elements of the present invention can be positioned in any type of shape. For instance, as shown in FIG. 3, actuator element 110 in the first phase can be any type of curved shape. However, the actuator element can also be any type of non-linear shape or any type of irregular shape as long as a strain gradient can be established. FIG. 3 shows a rotary action or movement of actuator element 110. Although, the example in FIG. 3 shows a linear position in the second phase, the second phase does not have to be perfectly linear, it could also be substantially linear or less curved compared to the first phase as long as it is in the direction to minimize the strain gradient.

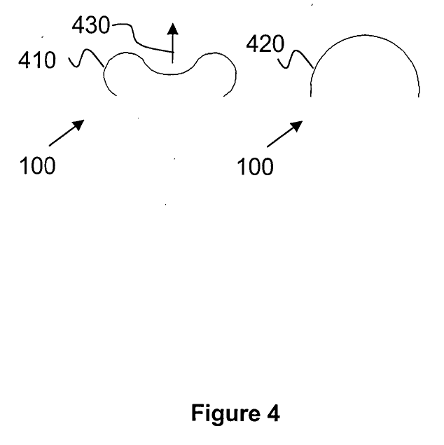

In addition to the examples described above, initially holding a linear shape memory element in a non-linear shape with an initial strain gradient imposed around the neutral axis of the element, enables overall strain gradient to be maximized in the first phase. The maximized force is exerted in a pre-determined direction during phase transformation. Once the actuator is activated, increased stiffness in the second phase moves the actuator in a pre-determined direction that minimizes the initial strain gradient. Thus, using the same straight/linear element 110, different types of motion and output force can be designed depending on how the strain gradient is formed initially. This is exemplified in FIG. 4.

Unlike the linear starting shape for the first phase as shown in FIG. 3, FIG. 4 shows actuator element 110 with a non-linear starting shape 410 in the first phase before activation. In this initial shape, overall strain gradient is maximized in the first phase. Once actuator element 110 is activated, a transition occurs to minimize the strain gradient and maximize the output force in the second phase. The resulting second phase can also be in any type of shape as shown by 420. In this case, second phase shape 420 is another non-linear shape. Furthermore, FIG. 4 shows an upward movement 430 that is generated by actuator element 110 to minimize the strain gradient after activation.

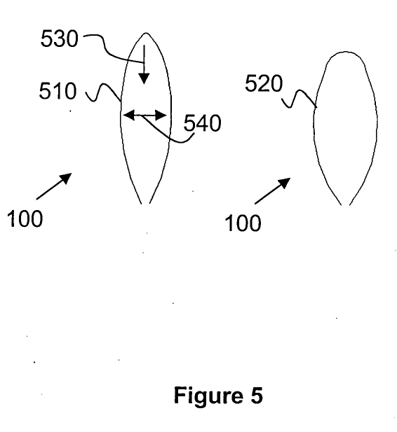

FIG. 5 shows actuator element 110 with another non-linear shape 510 in the first phase before activation by activation means. Once actuator element 110 is activated, the actuator element 110 transitions to the second phase to minimize the strain gradient and maximize the output force. The resulting second phase can also be in any type of shape 520 with minimized strain gradient after activation. In this case, shape 520 is a different non-linear shape compared to 510. Furthermore, FIG. 5 shows a downward movement 530 that is generated by actuator element 110 to minimize the strain gradient. Additionally, FIG. 5 shows an expanding (rotary) action or movement by actuator element 110 as indicated by 540. As one skilled in the art will appreciate, so long as the actuator element can retain a strain gradient variation, they can be arranged in various shapes/configurations and can generate different types of linear, rotary, expanding movements or actions. Moreover, the present invention is not limited to any combination of different movements or actions such as a combined linear and rotary movement. The linear actions generated from strain gradient variation can be combined with contraction motion and implemented to produce stronger force with larger deflection.

Compared to conventional actuators that are purely based on shape memory effect, the present invention provides a way to control/manipulate output movement and force of the SMA actuators independent of originally fabricated or memorized shape (e.g., linear or curved shape). This ability to control/manipulate takes advantages of strain gradient changes during phase transformation and is not limited by the fixed contraction strains (4˜5%) of conventional SMA actuators. This approach allows and enables the miniaturization of SMA actuators to meso or micro-scale.

Accordingly, the present invention also includes a method of making an actuator. The first step is to obtain an actuator element capable of retaining strain gradient variation, preferably an SMA. The second step is to develop and establish a strain gradient variation between a first phase and a second phase of the actuator element as discussed above with reference to FIGS. 1 and 2. The actuator element can be arranged/positioned in any kind of configuration which is dependent on the type of action or movement one wants to achieve. The third step is to activate the actuator element and transition the actuator element from the first phase to the second phase as discussed above. The activation can be achieved with an activating means such as a heating element.

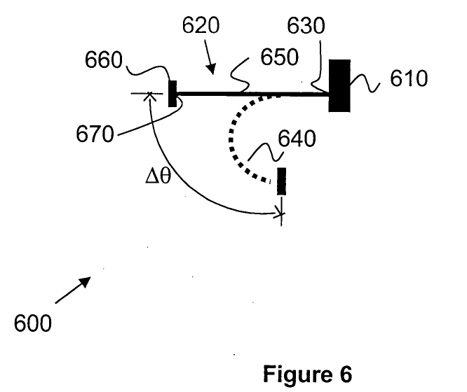

The actuator of the present invention can also be embedded in or otherwise integrated into a device 600 as shown in FIG. 6. As an exemplary embodiment, such an actuator device could include a first body 610. The actuator element 620 as discussed above, could then be attached with a first end 630 to first body 610. Such a device could be used as, for instance, but not limited to, a switch or relay where the other end, in particular the end that is not attached, plays a role in the switching or relay action when the actuator element transitions from the first phase 640 to the second phase 650. The actuator device could further include a second body 660 that is attached to a second end 670 of the actuator element 620.

Alternatively (not shown), the second end could also be attached to the first body so that the actuator element, for instance, is configured in a curved position. A second body could then be attached to a point in between the first end and the second end. This type of configuration is beneficial in a linear movement when one wants to translate the movement from actuator element to the second body.

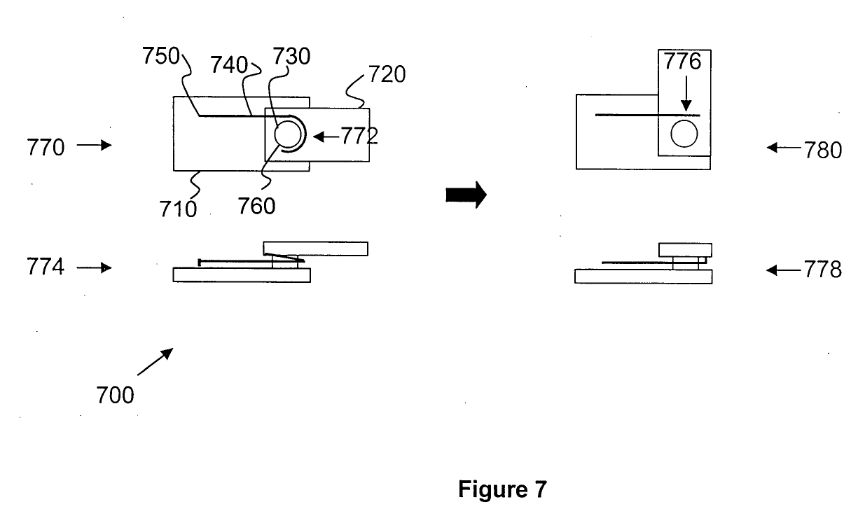

In another example as shown in FIG. 7, the device 700 of the present invention includes a first body 710 which is movably attached to a second body 720 by a connecting means 730. Examples of connecting means are, for instance, but not limited to, a joint, any other structure that movably connects two bodies or the like. Actuator element 740, as discussed above, is attached with a first end 750 to first body 710 and by a second end 760 to second body 720. 770 shows a top view of actuator element 740 in the first position which is a curved shape 772 that imposes a strain gradient to actuator element 740 (774 shows a side view of 770). 780 shows a top view of actuator element 740 in the second position which is a linear shape 776 (778 shows a side view of 770). When actuator element 740 is heated up, a phase transformation occurs such that the actuator element 740 becomes stiff enough to bend itself from curled shape 772 to a memorized shape, which is linear shape 776 in this example, enabling the rotational motion. By following this configuration, the actuators of the present invention could achieve angular deflections of more than 60°. In some embodiments, the actuator element 740 are SMA wires embedded in the actuator device 700.

Accordingly, the present invention also includes a method of making an actuator device. The first step is to attach a first body with an actuator of the present invention. The actuator is attached to the first body via a first end thereof. The second step is to develop and establish a strain gradient variation between a first phase and a second phase of the actuator element as discussed above. The actuator element can be arranged/positioned in any kind of configuration, depending on the type of action or movement one wants to achieve. The third step is to activate the actuator element and transition the actuator element from a first phase to a second phase as discussed above. The activation can be realized with a heating means or any suitable means that causes the phase transformation to occur.

In one embodiment, the method further includes attaching a second body to a second end of the actuator element. The first body could then be movably attached to the second body by a connecting means, such as a joint. In an alternative embodiment, the method further includes attaching a second body to a point in between the first end and the second end of the actuator element. The second end is now attached to the first body. Optionally, depending on applications and relevant requirements, the method includes embedding the actuator in the actuator device.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For instance, the present invention can be applied to actuators for large angular motion as well as to other applications, such as, but not limited to, medical devices, robotic devices, joint mechanisms or switches or relays to turn on/off electric circuits. The SMA can be modified to be in various shapes, such as, an arc-shape, a P-shape, a W-shape and the like, to simplify and/or improve the actuator system. Some specific steps involved in fabricating the actuators and enhancing the actuator bandwidth can be added to the present invention. First, in case of embedding an SMA in a device, one might consider electroplating (fixturing and cooling) of the SMA. One might also consider a self-locking mechanism of the SMA. Second, with regards to materials and process combinations, one might consider, materials with high thermal conductivity but low electrical conductivity (such as Si, Ge and the like). Furthermore, shape deposition manufacturing (SDM) is preferred when embedding, for instance, Si parts into SDM structures to create an Si actuator device. All such variations are considered to be within the scope and spirit of the present invention as defined by the following claims and their legal equivalents.

What is claimed is:

1. An actuator comprising:
an actuator element having a first part, a second part, and a neutral axis therebetween along a cross-section of said actuator element; wherein
said actuator element capable of retaining a strain gradient defined relative to said neutral axis; wherein
said strain gradient is higher in a first phase, before activation of phase transformation, than in a second phase, after said activation; wherein
said actuator element has a first shape corresponding to said first phase and a second shape corresponding to said second phase; and wherein
once activated, said actuator element transitions from said first shape to said second shape in a direction to minimize said strain gradient.

2. The actuator as set forth in claim 1, wherein said actuator element is capable of achieving movement or angular deflection of about 60° or more.

3. The actuator as set forth in claim 1, wherein said first shape is characterized as non-linear, curvy, or irregular and wherein said second shape is characterized as linear or substantially linear.

4. The actuator as set forth in claim 1, wherein said first shape and said second shape are characterized as non-linear and wherein said second shape differs from said first shape.

5. A method of making the actuator of claim 1, comprising:
utilizing a shape memory alloy for said actuator element;
establishing said strain gradient by applying a torque to said actuator element such that said first part is under compression and said second part is under tension; and
activating said actuator element such that said actuator element transitions from said first phase to said second phase.

6. An actuator device, comprising:
a first body; and
an actuator element with a first end attached to said first body, said actuator element having a first part, a second part, and a neutral axis therebetween along a cross-section of said actuator element; wherein
said actuator element capable of retaining a strain gradient defined relative to said neutral axis; wherein
said strain gradient is higher in a first phase, before activation of phase transformation, than in a second phase, after said activation; wherein
said actuator element has a first shape corresponding to said first phase and a second shape corresponding to said second phase; and wherein
once activated, said actuator element transitions from said first shape to said second shape in a direction to minimize said strain gradient.

7. The device as set forth in claim 6, further comprising:
a second body attached to a second end of said actuator element.

8. The device as set forth in claim 7, wherein said first body is movably attached to said second body by a connecting means.

9. The device as set forth in claim 8, further comprising:
a second body attached to a point in between said first end and a second end of said actuator element, wherein said second end is attached to said first body.

10. The device as set forth in claim 9, wherein said actuator element is embedded in said actuator device.
